(19) United States
(12) Patent Application Publication
(10) Pub. No.: US 2015/0121186 A1
(43) Pub. Date: Apr. 30, 2015

(54) METHOD AND APPARATUS FOR INCREASING THE INFORMATION DENSITY IN INFORMATION PROVIDED ON THE PROGRESS OF A PROJECT

(71) Applicant: Aktiebolaget SKF, Gotenborg (SE)

(72) Inventors: Christian Genheimer, Schweinfurt (DE); Armin Herbert Emil August Olschewski, Schweinfurt (DE); Jasper Vennemann, Oldenburg (DE)

(73) Assignee: Aktiebolaget SKF, Gotenborg (SE)

(21) Appl. No.: 14/061,819

(22) Filed: Oct. 24, 2013

(51) Int. Cl. G06F 17/24

(52) U.S. Cl. CPC G06F 17/246
USPC 715/217

(57) ABSTRACT

A method for increasing the information density in providing information on a progress of at least one project, comprises providing at least one project related goal and at least one project related information, the project related information being related to the project related goal. The information characterizing the project related goal is arranged in a first cell in one element of the group of the cells of a first row of a table and the cells of a first column of the table and the information characterizing the project related information is arranged in a second cell of the other element of the group. An information cell of the table is colored in a first color when the goal is achieved and in a second, different color when the goal is not achieved.

### FIELD OF THE INVENTION

Embodiments of the present invention relate to a method for increasing the information density in information provided, and in particular, in information provided that is associated with the progress of a project.

### BACKGROUND OF THE INVENTION

A high information density for providing or displaying information on a particular subject or a project to be accomplished by multiple participants is of importance in many applications. Generally, it is desirable to increase the information density in information provided on the progress or the status of a particular project to the highest maximum extent so that participants in the project may, at a glance, be able to judge the progress of the project.

Conventionally, long project-related meetings are held so as to update the multiple participants in a particular project on the present status of the project. This may be time consuming and expensive, since the participants may be spread all over the world in larger organizations such as multinational companies.

It is, therefore, desired to increase the efficiency for project-related reviews and to increase the information density for providing or displaying project-related information, i.e., information on the progress of a project.

### SUMMARY OF THE INVENTION

According to some embodiments of the present invention, this is achieved by providing at least one project-related goal and at least one piece of project-related information, wherein the project-related information is related to the project-related goal. Information characterizing the project-related goal and the project-related information is arranged within a matrix. In particular, information characterizing the project-related goal is arranged either in a cell of the first row or of the first column within the matrix. Similarly, information characterizing the project-related information is arranged in a cell within the first row or the first column that is, in the row or column not used for the information related to the project-related goal. That is, the row and the column comprising the information on the project-related goal and the project-related information intersect at a particular cell within the table. This particular information cell is colored in a first color when the goal is achieved and in a second, different color when the goal is not achieved. To this end, the representation contains an extremely high amount of information, since, at a simple glance, one may determine that there is an interrelation between the project-related goal and the project-related information and to what extent the goal has already been achieved.

The project-related information may, for example, be an entity or a division within an organization, which is responsible for achieving the particular goal related to the project, so that it is immediately apparent which part of the organization is responsible for achieving the particular goal and whether the goal has already been achieved or not. Moreover, if more than one entity is responsible for achieving a particular goal within the project, additional entries for project-related information define further information where the particular rows and columns intersect, so that also when more than one entity is responsible for the achievement of a particular goal, it is immediately apparent which particular entities contribute to the achievement of the goal and which of the different entities has already successfully finished its task. According to further embodiments of the present invention, the project-related information indicates an item to be processed in the project such as, for example, a bearing or an engine to be developed. To this end, goals to be achieved for the particular item may be defined on the other axis of the column so that the overall project progress can be judged at a single glance. To this end, the project-related goals may indicate individual features of the item to be processed or manufactured, such as, for example, a reduction of fuel consumption by a predetermined amount or a reduction of noise emission of an engine or the like.

To this end, all relevant information to the project or to the item is visualized or provided in one single illustration or overview so that one is able to judge whether the complete project or the item is successfully developed to the end by a quick review of the associated table and by checking the progress on the individual goals, which is immediately apparent by the colors of the associated cells within the matrix. Therefore, the embodiments of the present invention increase the information density in providing information on the progress of a project to the maximum extent since, at a single glance, the progress of the overall project can be judged by illustrating all relevant interrelations between the project's goals and items or participants and the relevant information on the progress of the individual goals.

According to some embodiments of the present invention, the teaching of the present invention is used to provide a user interface increasing the information density in providing information on the progress of at least one project. To this end, the table comprising the information on the project-related goal and on the project-related information together with a color code within the information cell related to both categories is displayed on a display such as, for example, a computer monitor, a touch screen device, a tablet device, a smart-phone or the like. According to further embodiments of the invention, the user interface is interactive in that a user may select one particular information cell so that additional information related to the particular project-related goal and/or the project-related information associated to the selected information cell is displayed. That is, a user may, while already being informed on the overall progress of the project, easily gather additional information related to the particular goal or the particular project-related information associated to the selected information cell of the table. To this end, a user may, for example, gather information on the participants or the employees of a particular department or entity within an organization, which is responsible for achieving a particular goal of the project so that he may be enabled to contact particular individuals if, for example, the color code of the selected information cell indicates that the particular goal related to the project has not already been achieved. More generally speaking, in selecting an individual information cell, a user may gather more detailed information on the particular goal or on the particular entity related to the selected information cell, such as, for example, expected timelines, costs, human resources or the like.

According to some embodiments of the present invention, the user interface may be provided by a WAP- or a WWW-server, making its content accessible within a cooperation network or within the World Wide Web so that the individual participants in a project can gather all relevant information on the progress of the project from all over the world and with low effort. To this end, the user interface may be provided according to the HTML-standards over the World Wide Web so that it may be accessed via a WAP-browser or provided by any other appropriate means, such as, for example, by using especially designed applications (apps) for tablet PCs, smartphone operating systems or the like, so that simple access to all necessary information can be accessed with essentially no personal effort so that no additional time has to be consumed in order to get an overview on the progress of the project.

According to further embodiments of the present invention, the overall efficiency in providing information on the progress of at least one project may be further enhanced by providing for the possibility that individual participants in the project cannot only select one particular information cell in order to retrieve more detailed information. Moreover, some embodiments also provide for the possibility to introduce or update information for particular information cells. To this end, individuals responsible for particular goals related to individual information cells may update the status of the project-related goal, such as, for example, the completion of particular milestones or the updating of related timelines or the like. That is, individuals related to the project may only update the information related to their individual goals while, at the same time, updating the overall project progress without the need for time consuming long lasting meetings or the like.

To this end, a user responsible for a particular goal may manually update the status from “not achieved” to “achieved”, that is, causing a change of color of the related information cell in the table, or the user interface or the program logic underlying the user interface may estimate, based on the input of the user, whether the goal is achieved or not and hence, whether the representation of the color of the information cell is to be changed or not.

Some embodiments comprise a digital control circuit installed within the apparatus for performing the method. Such a digital control circuit, e.g. a digital signal processor (DSP), needs to be programmed accordingly. Hence, yet further embodiments also provide a computer program having a program code for performing embodiments of the method, when the computer program is executed on a computer or a digital processor.

### BRIEF DESCRIPTION OF THE FIGURES

FIG. 1 shows an example of an illustration according to one embodiment of a method for increasing the information density in providing information on the progress of a project;

FIG. 2 illustrates an exemplary embodiment of a method for increasing the information density as a flow chart;

FIG. 3 schematically illustrates an exemplary embodiment of an apparatus for providing a user interface increasing the information density in providing information on the progress of a project;

FIG. 4 shows an alternative illustration of the information arranged according to one particular exemplary embodiment of the present invention.

### DETAILED DESCRIPTION OF THE INVENTION

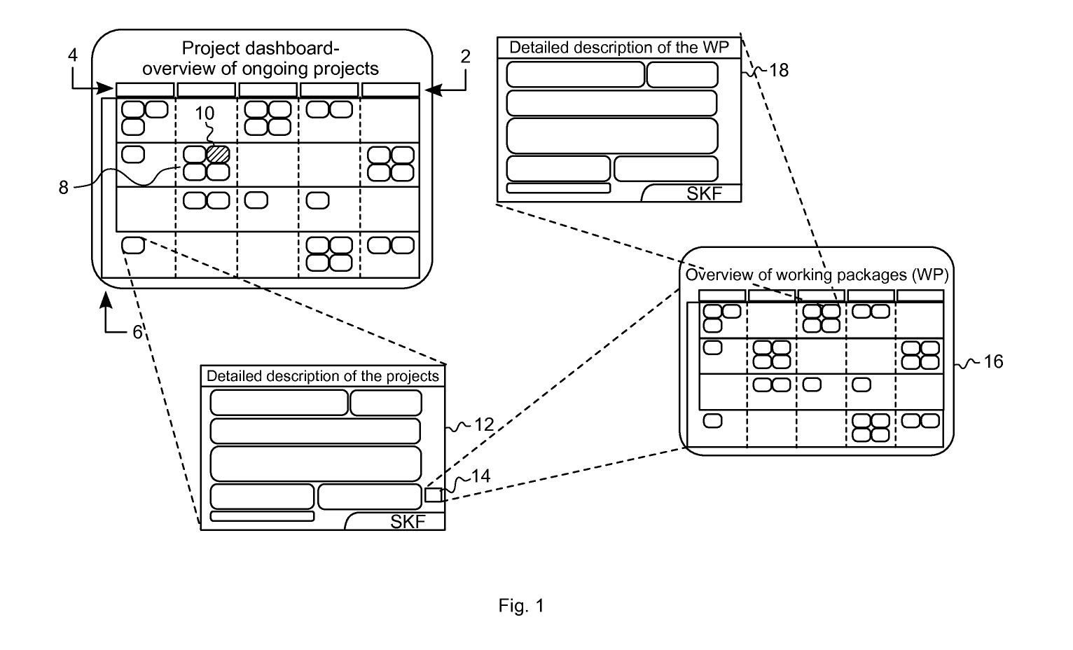

The top left illustration of FIG. 1 shows a particular example as to how information on the progress of at least one project may be provided within a table 2. In this particular embodiment, the table provides an overview of several presently ongoing projects. To this end, information characterizing project-related goals is arranged in the group of cells of the first row 4 of table 2. Project-related information which is related to the project-related goals is arranged in the group of cells of the first column 6 of the table 2. It goes without saying that the cell to the top left of the table remains empty due to the requirement to find intersecting information at cells that contain information on the relation between the project-related information and the project-related goals.

Just as an example one may consider that the project-related information illustrated in column 6 is information on the particular department contributing to the project within one company. While FIG. 1 illustrates the project-related information in the first column 6 and the project-related goals in the second column 4, further embodiments may also call for the second option, that is, to distribute the project-related information in the cells of the first row 4 and the information characterizing the project-related goals in the cells of the first column 6. Project-related information may, for example, be information indicative of a particular entity or division within a company contributing to the progress or, for example, information indicating a particular item to be processed or manufactured within the project. However, further embodiments may also use other information related to the project in the illustration according to FIG. 1. The information characterizing the project-related goal may be any information characterizing that goal, such as, for example, a short textual description of the particular goal or an item or a graphic representation of the goal to be achieved. For each pair of project-related information and project-related goal there exists one particular information cell of the table, which is determined by the intersection of the columns and rows as defined by the cells related to the particular information in the first row and the first column To this end, the position of the cell within the table may also be understood to define the relation between a project-related goal and an item of project-related information. The color of the information cell of the table indicates whether the goal as related to the project-related information has been achieved or not. Consider, for example, information cell 8 in table 2. When a color of the information cell 8 is indicative of completion of the project, one may immediately conclude that the project-related goal has, in so far it is related to the project-related information, been fully achieved. For example, if green indicates completion of the goal, a user or an individual accessing the table 2 may immediately conclude from the simple fact that all information cells are in green that the project has been completed.

As already illustrated in FIG. 1, the color code used to indicate the level of completion of the project-related goal may not only be used on the complete area of the intersection cell but also on sub-cells, as indicated by sub-cell 10. That is, in further embodiments, the project-related goals as related to the project-related information may also be displayed or provided as one or more sub-goals wherein the colorization of the sub-cells is indicative of the level of completion of the particular sub-goals. According to some further embodiments, the concept of using color codes to indicate the level of completion of a particular goal may be enhanced in using at least one or more additional colors so as to also indicate when the goal is only partly achieved. That is, for example, a third color may be used to indicate that the goal has been achieved by, for example, 30%. According to further embodiments, a color scale may be defined, wherein each color indicates a level of completeness within a range of predetermined percentages. The percentage to which extent a particular goal is judged to be complete may be agreed on beforehand based on an arbitrary matrix.

As illustrated in FIG. 1, further embodiments of the method for increasing the information density in providing information on the progress of at least one project introduce a hierarchical approach in that a particular cell or sub-cell of a user interface may be selectable. That is, the method or an entity for computing or providing that method may be operable to receive user input indicating a selection of a particular information cell, as illustrated in the bottom left illustration of FIG. 1. By selecting one particular cell or sub-cell, a user may be presented with more detailed information on the relationship between the project-related information and the project-related goal such as, for example, the names of the people involved in achieving the particular goal, the planned budget or the like. It goes without saying that the detailed information accessible by the selection of one particular cell can be chosen arbitrarily such as required by the particular project or following internal corporate standards.

The additional information related to the project-related goal and/or to the project-related information may be illustrated according to the information window 12 illustrated in FIG. 1 or in any other appropriate form of illustration.

As illustrated in FIG. 1, top left illustration, the user interface or the representation comprising the table 2 may furthermore hold strategic and/or other information. To this end, the project/initiative dashboard may provide for information and strategic challenges of the company, divided into the four main perspectives of the balanced scorecard approach. That is, the strategic goals of the company may be illustrated together with the table 2 so as to provide a link between the overall strategy and the particular project. Project/initiative names and status may be displayed, as well as a measure of the contribution of each project or initiative to the strategic goals of the company. Furthermore, the department being the driving force or responsible for driving the project or initiative may be displayed, as well as the project/initiative leader. Similarly, the working packages table 16 may provide an overview of all project-related working packages such as, for example, the name of the project, project members and functions, strategic goals of this particular project, the status of the individual working packages or the like. Depending on the arrangement of the information related to a goal of the project and the information on the project, matrix cells and/or the matrix may comprise information about responsible departments, regions, employees, applications, development phases, timelines or the like.

The information window 18 of high detail level may for example, comprise the same information as the information window 12 for the sub-project of the project described in the information window 12.

Some embodiments of the present invention follow a hierarchical approach so that also the information window 12 already containing more detailed information on the particular goal may provide for the opportunity to receive an additional user input, such as for example the icon 14 illustrated in the information window 12. Upon selection of the icon 14, information on the particular goal may be provided on a higher level of detail, as illustrated in FIG. 1, bottom right illustration. The particular illustration chosen may correspond to the form of illustration of table 2, that is, a further table 16 may be provided, illustrating a number of sub-projects or working-packages related to the goal described in information window 12. To this end, also on a higher level of detail, the illustration of the information in a table may be chosen. More generally speaking, some embodiments of the present invention increase the information density even further by providing information in an hierarchical approach, wherein on different levels of hierarchy the illustration of the projects or the associated sub-projects and information related to project-related goals or sub-project-related goals are illustrated in the form of a table using a color code to indicate the level of completion of the particular goals.

To this end, information windows of higher detail levels 18 may be used to provide information on a detailed description of individual working packages illustrated in the working packages table 16. It goes without saying that further embodiments may use more than two levels of hierarchy to increase the level of detail accessible from the table 2 providing information on the progress of a project with an extremely high level of information density.

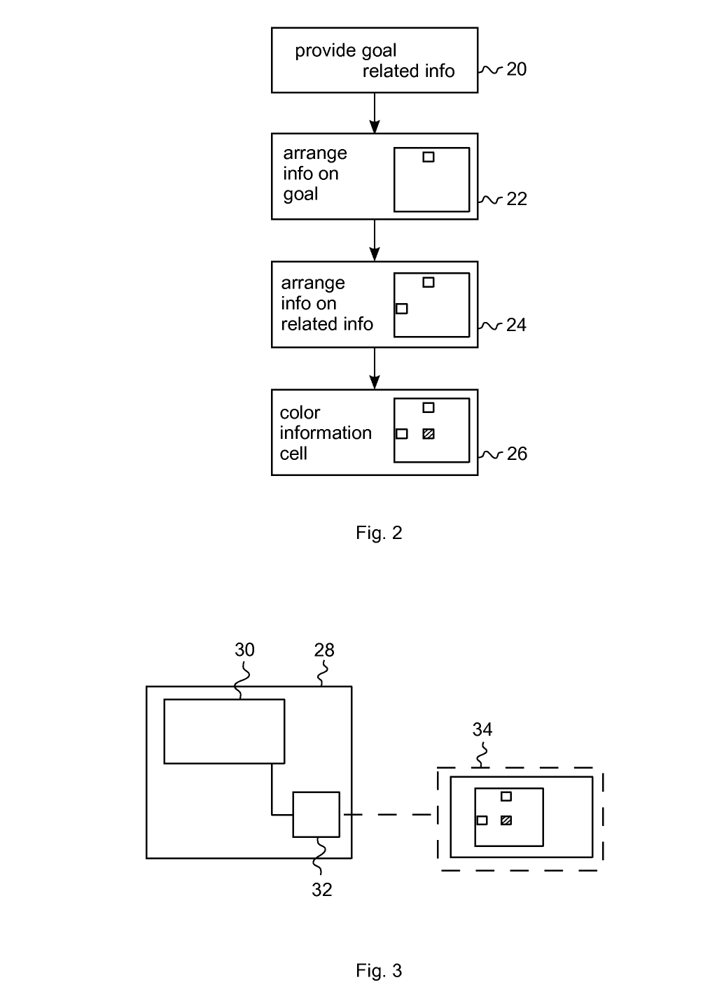

FIG. 2 illustrates an embodiment of a method for increasing information density in providing information on the progress of at least one project in a schematic view using a flow chart. In providing step 20, at least one project-related goal and at least one item of project-related information is provided, wherein the project-related information is related to the project-related goal.

In a first arranging step 22, information characterizing the project-related goal is arranged in a first cell in one element of the group of the cells of a first row of a table and the cells of a first column of the table. In a second arranging step 24, information characterizing the project-related information is arranged in the second cell of the other element of the group.

In a colorization step 26 an information cell of the table is colored in a first color when the goal is achieved and in a second, different color when the goal is not achieved. The information cell is determined by the intersection of the columns having one of the group of the first cell and the second cell in the first row and having the other cell of the group in the first column

Similar to FIG. 2, FIG. 3 illustrates, in a schematic sketch, an embodiment of an apparatus 30 for providing a user interface increasing the information density in providing information on the progress of at least one project. The apparatus 28 comprises a graphics creator 30 and a display signal creator 32. The graphics creator is operable to arrange information characterizing the project-related goal in a first cell in one element of the group of the cells of a first row of a table and the cells of a first column of the table. The graphics creator is further operative to arrange information characterizing the project-related information in the second cell of the other element of the group and to color the information cell in a first color when the goal is achieved and in a second, different color when the goal is not achieved.

Display signal generator 32 serves to provide a display signal for a display 34 such that the table is displayed on the display when the display is used. In order to illustrate the functionality, an optional display 34 is illustrated in FIG. 3 while it is to be noted that the display 34 is not part of the apparatus 28 as according to one embodiment of the present invention.

While using an embodiment of the present invention, globally acting companies may align ongoing activities in a cross-functional manner and in-between all management levels to guide the company in a strategic direction. This may be accomplished in a structured way because information related to one project or the global strategy is shared in an efficient way and people are not eaten up in daily business. The use of the concept described herein and the thinking behind it may help securing the strength in a company's position in a changing and fast developing industry and market by translating a long-term strategic vision in mid- to long-term projects.

This may particularly be achieved by aligning ongoing projects within a globally acting company and additionally align or connect those to the strategic visions of the company. The embodiments of the present invention may help to increase the information flow and communication about ongoing projects throughout the organization. Administrative effort for project leaders to create review material may be reduced. The efficiency of project review meetings may also be increased when the embodiments of the present invention are used on all company levels, which is to adopt reported information to the listeners' audience. In particular, only the vital elements are reported, which helps to increase the general understanding of the topic and opens up room for effective solution-guided discussions and decisions. To this end, long lasting project review meetings with questionable or no results may be eliminated, also providing for additional time for the participants on all employee levels. This, in turn, may create time for creative and innovative thinking along the lines of the communicated strategies of the company. This may also contribute to the creation of a culture of motivation and a spirit of being part of the change within the company due to the open communication of the development and the failure or success of the aligned strategic projects.

The achievable benefits may be grouped into four major groups. The first group is related to the leading of the company and the generation of a change in the company's direction in an aligned and strategic manner. To this end, due to the possibility for the top management to lead the company in an efficient and aligned way, long-term strategic challenges may be tackled effectively and solved over time. The changes within the company can be guided efficiently, supported and reported (communicated) without a loss of valuable time. The unified and structured approach brings strategy to life and makes strategy understandable within the organization.

The second group of advantages relates to higher efficiency and hence to the provision of more time for innovative thinking. To this end, the tool or the inventive methods may be implemented or stored on a global server and, therefore, be accessible to all decision makers any time and globally to update themselves on the status of the individual projects. A reduction of the reported project details to a sufficient minimum level (that is only to the vital elements) may be achieved, at the same time offering more detailed perspectives for review preparation.

The so achieved reduction of administrative efforts and time consumption for project reviews provides more time and ways for creative and innovative thinking for the participants in the projects. As a result, the chance to finalize projects in time also becomes higher due to the structured and strictly followed up approach. The user interface is provided and the information on the progress of the project as generated or provided by the embodiments of the present invention is especially easily understandable for all non-project members/stakeholders. Such cross-functional understanding opens up possibilities to support projects cross-functionally if necessary.

The third group of advantages is directed to an increase of employee motivation. A visualization and frequent communication of company improvements with time increases the motivation of the participants. Embodiments of the invention provide a way to point out the individual effects of each and every project and project member on the development of the company independently of the work level/area, which strengthens the identity within the company and therefore raises the level of motivation. Moreover, success within the organization is shown and communicated to all employee levels in an understandable manner. Moreover, a high level of frustration throughout the company caused by lengthy information review meetings can be avoided and an increased project finalization or cancellation rate may be achieved by guided communication.

The fourth group of advantages is directed to an increased transparency and a systematic working structure. Embodiments of the present invention provide an improvement for knowledge-based decision-making. Increased project success, decreased project finishing times and decreased project cancellation rates may be achieved because the decision makers understand the project and the scope/consequences of their decisions better and easier. Furthermore, increased transparency within the organization is achieved and a higher chance to support projects and their outcome is also achieved. The matrix structure may be fully adapted to the needs of the organization, that is, the embodiments of the present invention are highly flexible with respect to the application scenarios.

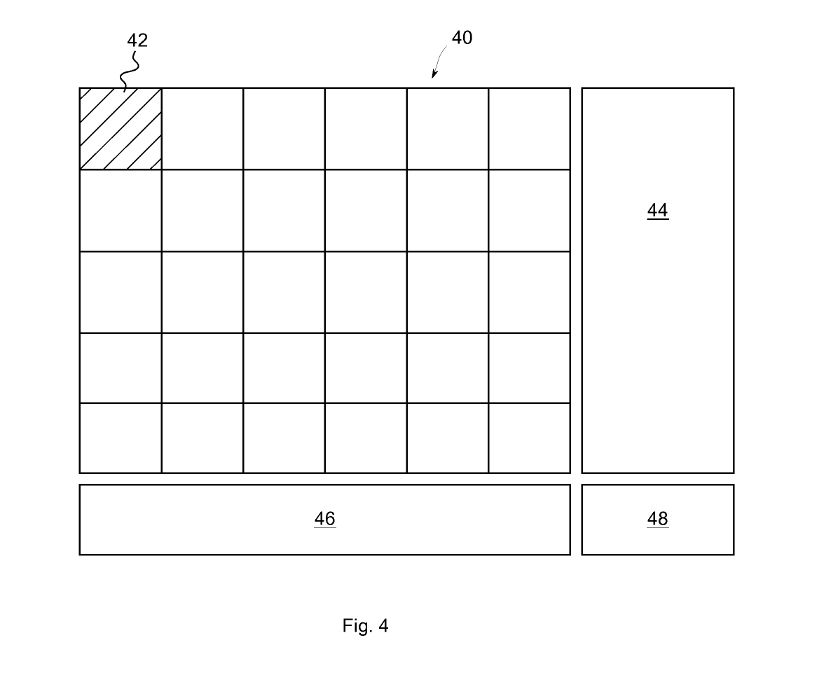

FIG. 4 illustrates a particular embodiment in a user interface comprising a table 14 as elaborated on in the previous paragraph as well as further areas displaying content according to the balanced scorecard approach. To this end, the first information area 42 may display content describing the strategic challenges of the company within the strategic horizon in a spider chart. The spider chart methodology visualizes the implications/interactions between those challenges. The decision which challenges the company will face and concentrate on should be the result of a structured strategy process in which all relevant departments may contribute. In the first row of table 40, one or more strategic challenges the company focuses on may be illustrated as part of a dashboard matrix. The cells of the first column of table 40 may indicate all departments of the company. That is, the items of information disclosed or provided in the cells of the first row or in the cells of the first column are directly related to each other and may be individually defined and adjusted according to the usage of the dashboard. Examples for information on an ongoing project and associated goals achieved by the project may be: countries vs. departments; regions vs. application areas; customers vs. competencies; products vs. time phases and so on. When using this approach, the cells of the table 40 display or indicate all strategic projects/initiatives of the company. The colors of the rectangles inform about the status of each project. The frames of each project/initiative rectangle visualize the strategic goal of each project and therefore it is easy to get an overview about which department is running what kind of project with which strategic goal. All rectangles may be hyperlinked to the project/initiative descriptions. Cross-functional or cross-challenging projects may be visualized by bigger project boxes, which can cross the matrix borders.

The second information area 44 may provide information on strategic projects/initiatives in an overview. This may, for example, be achieved by illustrating a list of all ongoing projects. Information provided for the particular projects may, for example, be project or initiative number, project or initiative status, name or leader or the like.

In the third information area 46 the strategic goals of the company may be highlighted in order to emphasize the importance of the strategy for the company and interrelate the strategy to the individual projects. That is, the strategy of the company and the main strategic goals of the company may be displayed in the third information area. By doing this, the strategy and the strategic goals will become more handy and the company development in the strategic direction may be communicated in a better way.

The fourth information area 48 may, for example, comprise a legend, that is, an explanation of the color codes and the associated project status of the projects represented by the cells of the table 40. In summary, the matrix or table 40 displays in the information cells projects which are headed by the departments indicated in the cells of the first column of the table, wherein the individual challenges faced by the whole company are displayed or shown in the cells of the first row of the table. In particular, the individual goals defined in the cells of the first row of the table 40 serve to reach the company's strategic goals and targets as displayed in the third information area 46.

Summarizing in other words, the idea is that only the vital points of each project/initiative are reported. The project leader is responsible to fill in the information in advance of a review meeting. It is really important that the project team defines a timeline and a budget at the beginning of the project, because this information is impacting the status of the project/initiative largely. Once the status of the project is changed, the status of the project in the dashboard, i.e. in the matrix, will change accordingly. It is not required that all details are shared and discussed with this audience. The project leader informs the audience about the vital elements of each project and asks for decisions and/or help if necessary. An overview of all project related working packages is given. If the audience or somebody is interested in more project details, there is the opportunity to click on a detailed overview of all working packages of the project. To minimize the administrative effort, initiatives may not be reported in such a detailed level. The working packages of projects are reported in a matrix structure and the matrix dimensions should be adjusted to the project needs/structure.

All working packages may be assigned to specific working package leaders who are responsible to run the working package and update the project leader about the progressions, that he is able to change the overall project status accordingly. Examples for dimensions are: regions, departments, employees, applications, development phases, time and the like.

If further information is requested it is possible to describe the vital elements of each working package in the same way as it is done on project. Following the same approach as described above for the projects/initiatives, the vital elements of each working package may also be reported. Each leader of a working package may update the details of his working package and change the status accordingly before each review meeting, because this will also impact the decision about the reported status of the project itself which is reported by the project. This concept/method or tool really focuses on the strategy translation or realization and helps to create a higher level of transparency and motivation in the company than any balanced scorecard or key performance indicator-reporting is able to supply/create. At the same time this is a powerful approach for a strategy guided and long lasting change process.

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Functional blocks denoted as “means for . . . ” (performing a certain function) shall be understood as functional blocks comprising circuitry that is adapted for performing a certain function, respectively. Hence, a “means for s.th.” may as well be understood as a “means being adapted or suited for s.th.”. A means being adapted for performing a certain function does, hence, not imply that such means necessarily is performing the function (at a given time instant).

Functions of various elements shown in the figures, including any functional blocks labeled as “means”, “means for . . . ”, “. . . ”, etc., may be provided through the use of dedicated hardware, such as “. . . ”, “. . . ”, “a processor”, “a controller”, etc. as well as hardware capable of executing software in association with appropriate software. Moreover, any entity described herein as “means”, may correspond to or be implemented as “one or more modules”, “one or more devices”, “one or more units”, etc. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective steps of these methods.

Further, it is to be understood that the disclosure of multiple steps or functions disclosed in the specification or claims may not be construed as to be within the specific order. Therefore, the disclosure of multiple steps or functions will not limit these to a particular order unless such steps or functions are not interchangeable for technical reasons. Furthermore, in some embodiments a single step may include or may be broken into multiple sub steps. Such sub steps may be included and part of the disclosure of this single step unless explicitly excluded.

### LIST OF REFERENCE NUMBERS

2 table
4 first row
6 first column
8 information cell
10 sub-cell
12 information window
14 icon
16 working packages table
18 information window of high detail level
20 providing step
22 first arranging step
24 second arranging step
26 colorization step
28 apparatus
30 graphics creator
32 display signal creator
34 display
40 table
42 first information area
44 second information area
46 third information area
48 fourth information area

1. A method for increasing the information density in information provided that is associated with a progress of at least one project, the method comprising:
providing at least one project related goal and at least one project related information, the project related information being related to the project related goal;
arranging information characterizing the project related goal in a first cell in one element of the group of the cells of a first row of a table and the cells of a first column of the table;
arranging information characterizing the project related information in a second cell of the other element of the group; and
coloring an information cell of the table in a first color when the goal is achieved and in a second, different color when the goal is not achieved, wherein the information cell is determined by the intersection of the column having one of the group of the first cell and the second cell in the first row and the row having the other one of the group in the first column

2. The method according to claim 1, further comprising:
coloring the information cell in a third color when the goal is at only achieved partly.

3. The method according to claim 1, wherein the project related information indicates an item to be processed in the project.

4. The method according to claim 1, wherein the project related information indicates an entity of an organization responsible for achieving the goal.

5. The method according to claim 1, wherein the project related goal indicates a feature of an item to be processed or manufactured within the project.

6. A method for providing a user interface that increases the information density in information provided that is associated with a progress of at least one project, the project having at least one project related goal and at least one project related information, the project related information being related to the project related goal, the method comprising:
arranging information characterizing the project related goal in a first cell in one element of the group of the cells of a first row of a table and the cells of a first column of the table;
arranging information characterizing the project related information in a second cell of the other element of the group;
coloring an information cell of the table in a first color when the goal is achieved and in a second, different color when the goal is not achieved, wherein the information cell is determined by the intersection of the column having one of the group of the first cell and the second cell in the first row and the row having the other one of the group in the first column; and
displaying the table.

7. The method of claim 6, further comprising:
receiving a user input indicating a selection of the information cell; and
displaying additional information related to the project related goal and/or the project related information.

8. The method of claim 6, further comprising:
receiving a user input having updated information related to a particular information cells.

9. The method of claim 8, wherein the updated information indicates the achievement of the project-related goal associated with the particular information cells.

10. The method of claim 8, wherein the updated information indicates the change of a color of the particular information cell.

11. An apparatus for providing a user interface that increases the information density in information provided that is associated with a progress of at least one project, the project being characterized by at least one project related goal and at least one project related information, the project related information being related to the project related goal, the apparatus comprising:
a graphics creator operable to arrange information characterizing the project related goal in a first cell in one element of the group of the cells of a first row of a table and the cells of a first column of the table;
arranged information characterizing the project related information in a second cell of the other element of the group;
an information cell of the table colorized in a first color when the goal is achieved, and in a second, different color when the goal is not achieved, wherein
the information cell is determined by the intersection of the column having one of the group of the first cell and the second cell in the first row and the row having the other one of the group in the first column; and
a display signal generator operable to provide a display signal for a display such that the table is displayed on the display when the display signal is used.

12. The apparatus of claim 11, further comprising:
a user input evaluator operable to evaluate a user input indicating a selection of the information cell; wherein
the graphics creator is further operable to create a representation of additional information related to the project related goal and/or the project related information when the selection of the information cell has been indicated; and wherein
the display signal generator is operable to provide a display signal such that the representation is displayed when the selection of the information cell has been indicated.

13. A computer program for, when running on a processor or on programmable hardware, performing a method comprising:
providing at least one project related goal and at least one project related information, the project related information being related to the project related goal;
arranging information characterizing the project related goal in a first cell in one element of the group of the cells of a first row of a table and the cells of a first column of the table;
arranging information characterizing the project related information in a second cell of the other element of the group; and
coloring an information cell of the table in a first color when the goal is achieved and in a second, different color when the goal is not achieved, wherein the information cell is determined by the intersection of the column having one of the group of the first cell and the second cell in the first row and the row having the other one of the group in the first column

14. A computer program for, when running on a processor or on programmable hardware, performing a method for providing a user interface that increases the information density of provided information on a progress of at least one project, the project being characterized by at least one project related goal and at least one project related information, the project related information being related to the project related goal, the method comprising:
arranging information characterizing the project related goal in a first cell in one element of the group of the cells of a first row of a table and the cells of a first column of the table;
arranging information characterizing the project related information in a second cell of the other element of the group;
coloring an information cell of the table in a first color when the goal is achieved and in a second, different color when the goal is not achieved, wherein the information cell is determined by the intersection of the column having one of the group of the first cell and the second cell in the first row and the row having the other one of the group in the first column; and
displaying the table.
